(19) United States
(12) Patent Application Publication
(10) Pub. No.: US 2017/0011551 A1
(43) Pub. Date: Jan. 12, 2017

(54) GARMENT CAPTURE FROM A PHOTOGRAPH

(71) Applicants: MoonHwan JEONG, Seoul (KR); Hyeong-Seok KO, Seoul (KR); Dong-Hoon Han, Seoul (KR)

(72) Inventors: MoonHwan JEONG, Seoul (KR); Hyeong-Seok KO, Seoul (KR); Dong-Hoon Han, Seoul (KR)

(21) Appl. No.: 14/793,664

(22) Filed: Jul. 7, 2015

(51) Int. Cl. G06T 17/20; G06K 9/46; H04N 5/225; G06T 17/10; G06T 19/20

(52) U.S. Cl. CPC G06T 17/20; G06T 17/10; G06T 19/20; H04N 5/225; G06K 9/4604; G06T 2215/16; G06T 2200/08; G06T 2210/16

(57) ABSTRACT

Provided is a new method which creates the virtual garment from a single photograph of a real garment put on to the mannequin. The method uses the pattern drafting theory in the clothing field. The drafting process is abstracted into a computer module, which takes the garment type and primary body sizes then produces the draft as the output. Then the problem is reduced to find out the garment type and primary body sizes. That information is found by analyzing the silhouette of the garment with respect to the mannequin. The method works robustly and produces practically usable virtual clothes that can be used for the graphical coordination.

### BACKGROUND OF THE INVENTION

The present invention relates to a method for garment capture from a photograph.

### SUMMARY OF THE INVENTION

The present invention contrives to solve the disadvantages of the prior art.

An object of the invention is to provide a method for garment capture from a photograph.

The method for garment capturing from a photograph of a garment comprises steps for:

inputting a photograph of the garment;

extracting a silhouette of the garment from the photograph;

identifying a garment type and a plurality of primary body sizes (PBSs) and creating a plurality of sized drafts;

generating a plurality of panels using the garment type and the plurality of PBSs; and

draping the plurality of panels on a mannequin.

The method may further comprise, prior to the step for inputting, steps for: providing a camera and the mannequin, wherein the positions of the camera and the mannequin are fixed, so that photographs taken with and without the garment have pixel-to-pixel correspondence; and pre-processing the mannequin to obtain and store three-dimensional geometry of the mannequin and primary body sizes (PBSs).

The step for pre-processing the mannequin may comprise steps for: scanning the mannequin; modeling the scanned data graphically; and storing the graphically modeled data in a computer file.

Relationship between real world distance and pixel distance of a plurality points of the mannequin and an environment in which the camera and the mannequin are disposed is established a computer using the graphically modeled data.

The step for extracting a silhouette may comprise a step for providing a base mask by subtracting an exposed mask from a mannequin mask, and the mannequin mask is obtained from the input photograph of the mannequin and the exposed mask comprises a non-garment region of the input photograph.

The step for identifying a garment type may comprise a step for searching a closest match from choices in a garment type database using

$$arg {min}_{{S}_{D}} ‖ {TS}_{I} - {S}_{D} ‖ , \qquad ( 1 )$$

where S_{I} is an input garment silhouette image, S_{D} the silhouette in the garment type database, and T a transformation comprising an arbitrary combination of rotation, translation, and scaling.

The garment type database may comprise a plurality of classes and subclasses.

The step for identifying a plurality of primary body sizes (PBSs) may comprise a step for identifying, labeling, and pre-registering of mannequin-silhouette landmark points (MSLPs) and garment-silhouette landmark points (GSLPs).

The plurality of primary body sizes (PBSs) may be identified by searching candidate points of the garment-silhouette according to

where M_{F} is one of the filters shown in FIG. 6, M_{L} is the square fraction of the silhouette image.

$$arg {min}_{{M}_{L}} ‖ {M}_{F} - {M}_{L} ‖ , \qquad ( 2 )$$

The method may further comprise a step for extracting one-repeat texture from the input photograph.

The step for extracting one-repeat texture may comprise steps for eliminating distortion first and then extracting the one-repeat texture from an undistorted image.

The step for extracting one-repeat texture may comprise a step for extracting lines by applying the Sobel filter, then constructing a 2D triangle mesh based on the extracted lines.

A deformation transfer technique may be applied to straighten the 2D triangle mesh, using an affine transformation T as

T=\tilde{V}V⁻¹ (3)

for each triangle, where V and V− represent undeformed and deformed triangle matrices, respectively, and using only a smoothness term E_{S} and an identity term E_{I},

$$\begin{matrix}{E}_{S} = {\sum }_{i = 1}^{\vert t \vert} {\sum }_{j ∈ adj ( i )} {‖ {T}_{i} - {T}_{j} ‖}_{F}^{2} & ( 4 ) \\ {E}_{I} = {\sum }_{i = 1}^{\vert t \vert} {‖ {T}_{i} - I ‖}_{F}^{2} & ( 5 )\end{matrix}$$

and formulating the optimization problem as

$$\begin{matrix}{min}_{{\tilde{V}}_{1} … {\tilde{V}}_{n}} E = {w}_{S} {E}_{S} + {w}_{I} {E}_{I} & ( 6 ) \\ subject to \\ {y}_{{\tilde{V}}_{i}} = {y}_{{\tilde{V}}_{j}} ( i , j ∈ {L}_{h} ) \\ {x}_{{\tilde{V}}_{i}} = {x}_{{\tilde{V}}_{j}} ( i , j ∈ {L}_{v} ) & \end{matrix}$$

where w_{S} and w_{I} are the user controlled weights, Lₕ and Lᵥ are horizontal and vertical lines, respectively, and y_{V-i} is y coordinate of vertex i.

Although the present invention is briefly summarized, the fuller understanding of the invention can be obtained by the following drawings, detailed description and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 shows that the proposed method GarmCap takes a photograph (a) and produces its 3D virtual garment (b);

FIG. 2 shows a setup for the garment capture;

FIG. 3 shows an one-piece dress draft, which can be determined from the primary body sizes summarized in Table 1;

FIG. 4 shows steps the proposed garment capture technique (GarmCap);

FIG. 5 shows steps for obtaining the garment silhouette and landmarks: (a) base mask, (b) garment silhouette, (c) mannequin-silhouette landmark points (red) and garment-silhouette landmark points (blue);

FIG. 6 shows filters for identifying the GSLPs;

FIG. 7 shows extraction of the texture: (a) original image, (b) triangle mesh, (c) deformed image, (d) deformed mesh, (e) one-repeat texture;

FIG. 8 shows input photograph (left) vs. captured result (right), in which the captured result was obtained by performing physically-based draping simulation on the 3D mannequin model;

FIG. 9 shows a side and rear view of FIG. 8(a);

FIG. 10 shows draping captured garment on the avatar; and

FIG. 11 shows panels for the captured result shown FIG. 1.

### DETAILED DESCRIPTION EMBODIMENTS OF THE INVENTION

Referring to the figures, the embodiments of the invention are described in detail.

### 1. INTRODUCTION

Creation of virtual garments is demanded from various applications. This paper notes that such demand arises also from the consumers at home who would like to graphically coordinate the clothes in her closet to her own avatar. For that purpose, the existing garments need to be converted to virtual garments.

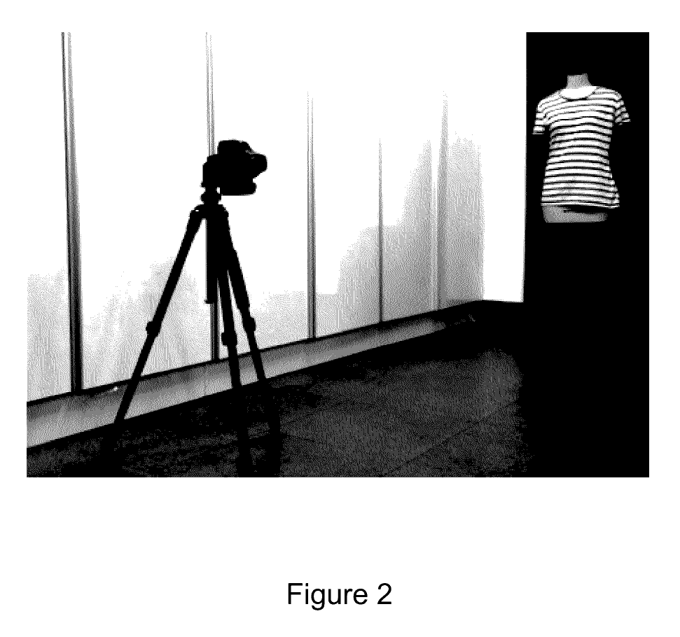

For the consumer, using the CAD programs for digitizing (i.e., identifying and creating the comprising cloth panels, positioning the panels around the body, defining the seams, extracting and mapping the textures, then draping on the avatar) her clothing collection is practically out of question. That job is difficult and cumbersome even for the clothing experts. This paper proposes a new method to instantly create the virtual garment from a single photograph of the existing garment put on to the mannequin, the setup of which is shown in FIG. 2.

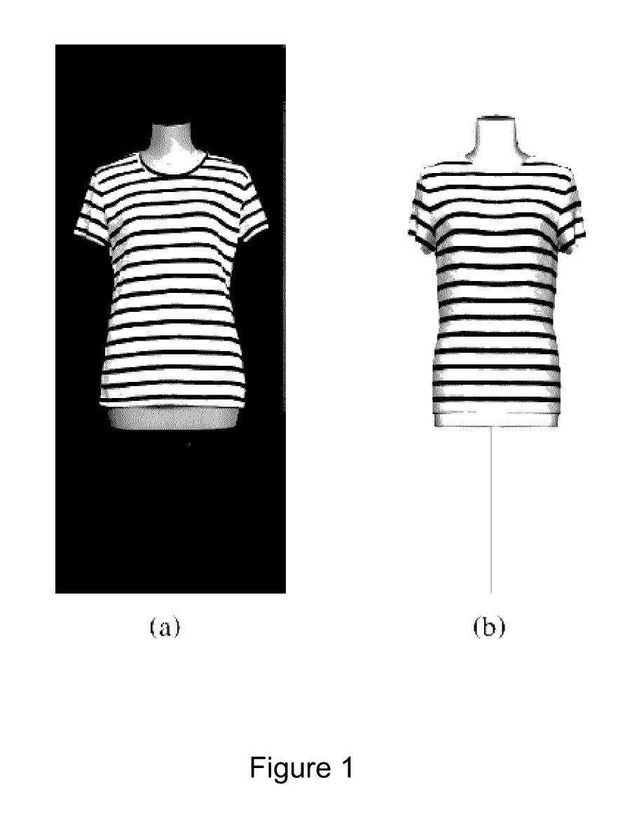

Millimeter-scale accuracy in the sewing pattern is not the quality this method promises. From insufficient information (thus easy to use), the method aims to create practically usable clothes that are just sufficient for the graphical outfit coordination. For the above purpose, the proposed method is very successful. As FIG. 1 and other reported results demonstrate, the method creates practically usable clothes and works very robustly.

We attribute the above success to the following two novel approaches this paper takes: (1) silhouette-based and (2) pattern-based. The use of vision-based techniques is not new in the context of virtual garment creation. Instead of trying to analyze the interior of the foreground, however, this paper devises a garment creation algorithm that utilizes only the silhouette, which can be captured a lot more robustly. This robustness trades-off with the foreground details such as buttons or collars, but we give up them in this paper to obtain a practically usable technique.

Another bifurcation this paper makes is, instead of working directly in the 3D-shape space, it works in the 2D-pattern space. In fact, our method is based on the pattern drafting theory which is well established in the conventional pattern-making study [1]. The proposed method is different from sketch or photograph based shape-in-3D-then-flatten approaches in that it does not call for flattening of the 3D surfaces. Flattening of a triangular mesh cannot be done in the theoretical (differential-geometrical) sense thus inevitably introduces errors, which emerge as unnaturalness to keen human eyes. Our method's obviation of the flattening significantly contributes to producing more realistic results.

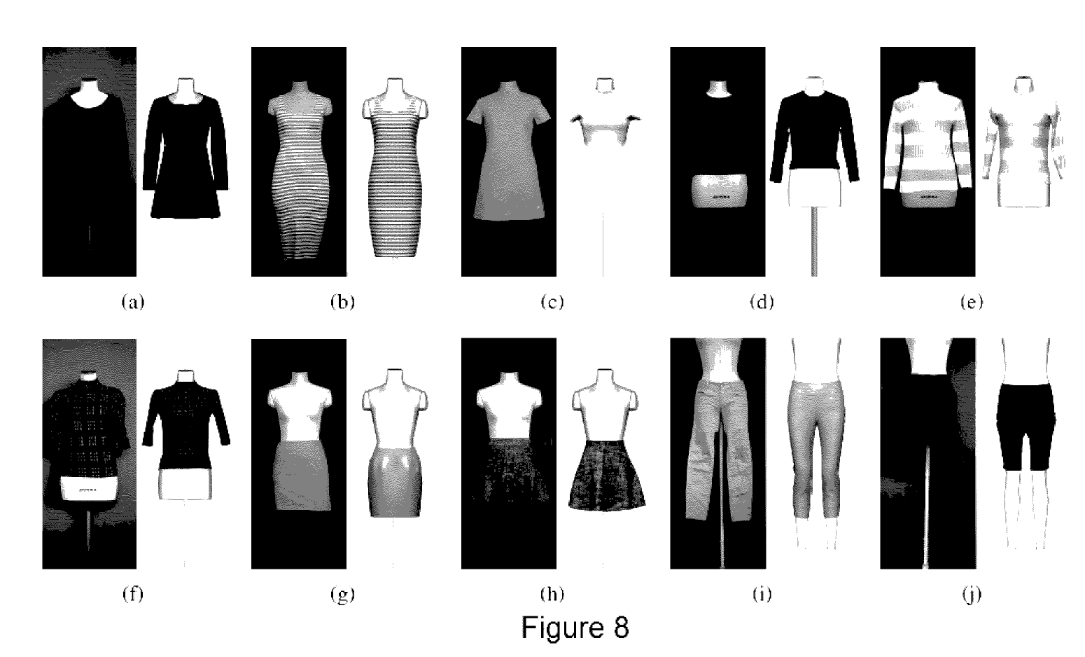

Since it is based on pattern drafting, our work is applicable only to the types of garments whose drafting is already acquired. In this work, the goal of which is to demonstrate the potential of the proposed approach, we limit the scope to simple casual designs (shirt, skirt, pants, and one-piece dress) shown in FIG. 8.

To summarize the contribution, to our knowledge, the proposed work is the first photograph based virtual garment creation technique that is based on the pattern drafting.

### 2. PREVIOUS WORK

In the graphics field, there have been various studies for creating virtual garments. Turquin et al. [2] proposed a sketch-based framework, in which the user sketches the silhouette lines in 2D with respect to the body, which are then converted to the 3D garment. Decaudin et al. [3] proposed a more comprehensive technique that improved Turquin et al.'s work with the developability approximation and geometrical modeling of fabric folds.

TABLE 1
Primary body sizes for one-piece dress draft

| Acronym | Meaning |
|---|---|
| WBL | Waist Back Length |
| HL | Hip Length |
| SL | Skirt Length |
| BiSL | Bishoulder Length |
| BP | Bust point to bust point Length |
| BC | Bust Circumference |
| WC | Waist Circumference |
| HC | Hip Circumference |

The recent sketch-based method [4] is based on context-aware interpretation of the sketch strokes. We note that the above techniques are targeted to novel garment creation, not to capturing existing garments.

Some researchers used implicit markers (i.e., printed patterns) in order to capture the 3D shape of the garment [5, 6, 7]. Tanie et al. [5] presented a method for capturing detailed human motion and garment mesh from a suit covered with the meshes which are created with retro-reflective tape. Scholz et al. [6] used the garment on which a specialized color pattern is printed, which enabled reproduction of the 3D garment shape by establishing the correspondence among multi-view images. White et al. [7] used the color pattern of tessellated triangles to capture the occluded part as well as the folded geometry of the garment. We note that the above techniques are applicable to specially created clothes but not to the clothes in the consumers' closet.

A number of marker-free approaches have been also proposed for capturing garments from multi-view video capture [8, 9, 10, 11]. Bradley et al. [8] proposed a method that is based on the establishment of temporally coherent parameterization between the time-steps. Vlasic et al. [9] performed the skeletal pose estimation of the articulated figure, which was then used to estimate the mesh shape by processing the multi-view silhouettes. Aguiar et al. [10] took the approach of taking the full-body laser scan prior to the video-recording. Then, for each frame of the video, the method recovered the avatar pose and captured the surface details. Popa et al. [12] proposed a method to reintroduce high frequency folds, which tend to disappear in the video-based reconstruction of the garment. We note that the above multi-view techniques call for somewhat professional setup for the capture.

Zhou et al. [13] presented a method that generates the garment from a single image. Since the method assume the garment is symmetric in front part and rear part, it is hard to generate realistic rear part of the garment. The result can be useful if the clothing expert applies some additional processing, but not quite sufficient for the graphical coordination of the garments.

### 3. OVERVIEW

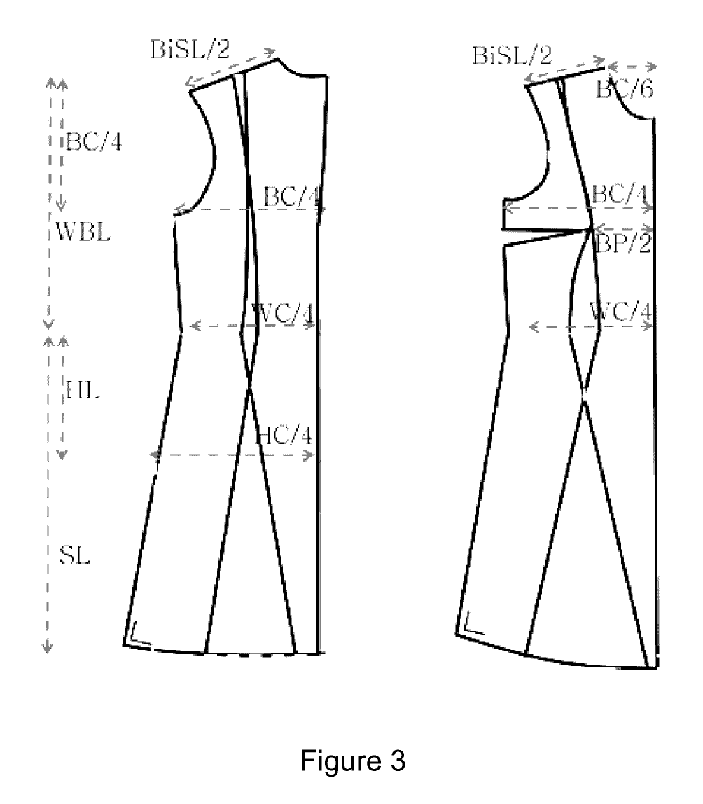

Our virtual garment creation is based on the drafts. Conventionally, there exists a draft (note that draft is different from the pattern; a draft is a collection of points and lines that are essential for obtaining the patterns or the cloth panels) for each garment type. FIG. 3 shows a typical draft for the one-piece dress. The whole set of the panels can be obtained by symmetrizing, mirroring, or making some variations to the draft.

We note that in fact the drafting can be done from the input of just a few parameters [14]. For the case of the one-piece dress draft shown in FIG. 3, the required input parameters are eight sizes which are summarized in Table 1. We call them the primary body sizes (PBSs). Since this work performs the garment capture in the context of pre-acquired drafts, the problem of converting the photographed garment to a 3D virtual garment can be reduced to the problem of identifying the garment type and the PBSs.

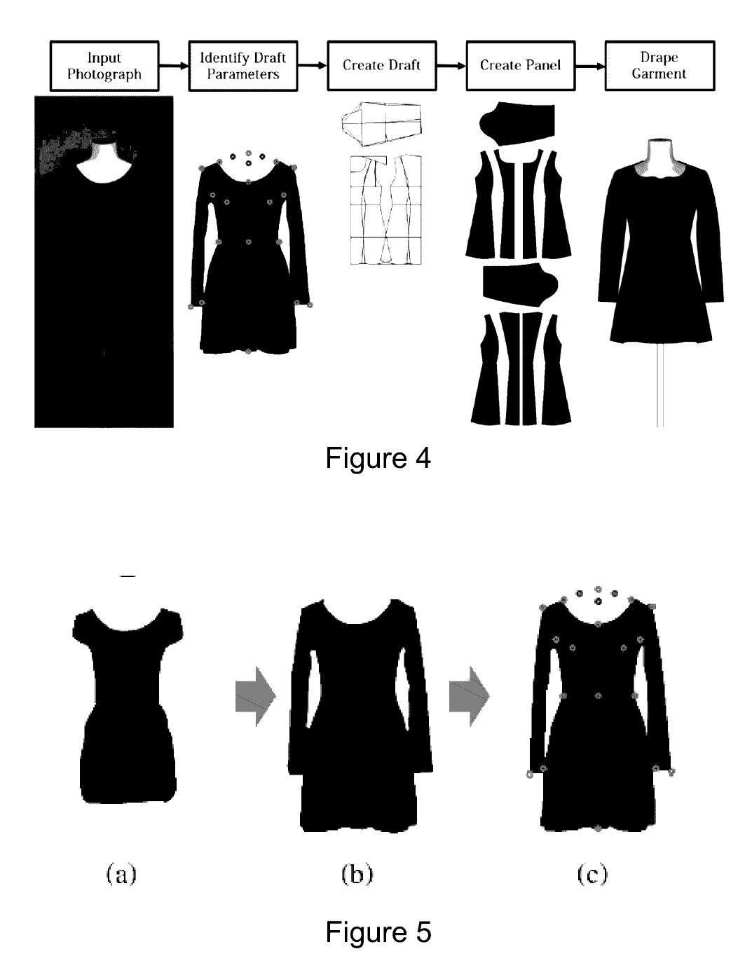

FIG. 4 overviews the steps of our garment capture technique (GarmCap). From the given photograph, it first extracts the garment silhouette. Based on the garment silhouette, it identifies the garment type and PBSs, which enables creation of the sized draft. Then, it can generate the comprising panels. Finally, it performs the physically-based simulation on the 3D mannequin or avatar.

### 4. GARMENT CAPTURE

This section presents each of the steps overviewed in FIG. 4.

### 4.1 Off-Line Photographing Set Up

Our photographing setup (FIG. 2) consists of a camera and a mannequin such that the photograph can be taken from the front. The positions of both the camera and the mannequin are fixed, so that the photographs taken with and without the garment can have pixel-to-pixel correspondence. We use the green background screen, which facilitates extraction of the foreground objects. In order to minimize the influence caused by the shadow, we tried to use lights of ambient nature as much as possible. We preprocessed the mannequin (scanned, graphically modeled, and stored into an OBJ file) to obtain its complete 3D geometry as well as its PBSs such that we can establish the relationship between real world distance and pixel distance.

### 4.2 Obtaining the Garment Silhouette

The first step of the GarmCap is the garment silhouette extraction, that is based on GrabCut [15] method. We already have the mannequin mask M_{M} obtained from the mannequin image. We can get the exposed mask M_{E}, the non-garment region of the input photograph. Subtracting M_{E} from M_{M} gives us the base mask M_{B}. FIG. 5 (a) shows the base mask of the input photograph in FIG. 4. By supplying this base mask, now the GrabCut can produce the garment silhouette without any user interaction. FIG. 5(b) shows the garment silhouette taken from the input photograph of FIG. 4 according to the above procedure.

### 4.3 Identifying the Garment Type

With the garment silhouette extracted in Section 4.2, we identify the garment type from the choices in the current garment type DB (shirt, skirt, pants and one-piece dress) by searching the closest match with

$$arg {min}_{{S}_{D}} ‖ {TS}_{I} - {S}_{D} ‖ , \qquad ( 1 )$$

where S_{I} is the input garment silhouette image (e.g., FIG. 5(b)), S_{D} is the silhouette in the DB, and T is a transformation that can take an arbitrary combination of rotation, translation, and scaling (same scales along each axis). After the garment type is identified, when needed, we subclassify the type. For example, after a garment is identified as a skirt, we further subclassify it whether it is A-line or H-line. For the case of the shirt, we subclassify it whether according to the sleeve and neckline. The subclassification is done in the similar way as described with Equation 1.

### 4.4 Identifying the PBSs

A few points on the surface of the mannequin are pre-registered as the mannequin-silhouette landmark points (MSLPs). Garmcap identifies them and labels them with red circles as shown in FIG. 5(c). Then, GarmCap labels a few feature points of the photographed garment with blue circles as shown in FIG. 5(c). We call them the garment-silhouette landmark points (GSLPs). For the center waist and bust points, the MSLPs and GSLPs coincide, thus the red circles are hidden behind the blue ones. But In general there can exist some discrepancy. For example, the discrepancy at the waist left and waist right, although they are in 2D, informs the ease at the waist. Note that the sleeve ends and the skirt end exist only as GSLPs, and indicate the length of the sleeves and the skirt.

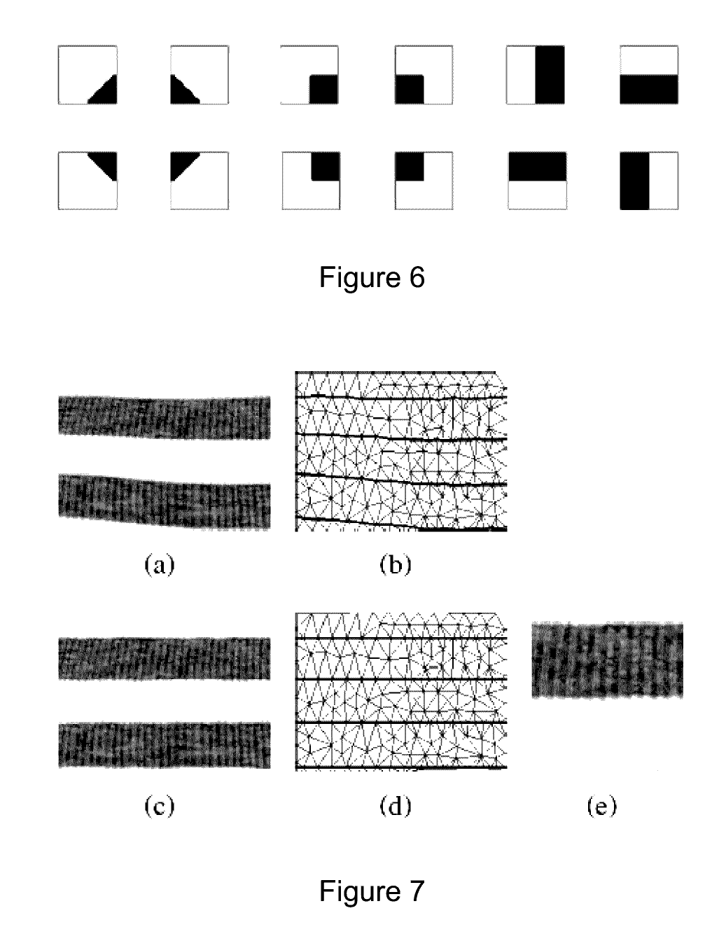

To identify the GSLPs from the garment silhouette, we search the candidate spots of the silhouette image according to

$$arg {min}_{{M}_{L}} ‖ {M}_{F} - {M}_{L} ‖ , \qquad ( 2 )$$

where M_{F} is one of the filters shown in FIG. 6, M_{L} is the square fraction of the silhouette image. Note that the above minimization is not mislead by the local minima since the searching is performed around MSLP. By performing the above search for the silhouette image with the transformation T in Equation 1 being applied, we do not need to consider the size mismatch here. Now, we can get the PBSs of the garment based on the GSLPs identified above. For the circumferences, we reference the geometry of the scanned mannequin body.

### 4.5 Texture Extraction

This section describes how we extract one-repeat texture from the input image. Texture is a significant part of the garment without which the captured result would look monotonous. Note that our work is not based on vision-based reconstruction of the original surface, but it reproduces the garment by pattern-based construction and simulation.

In that approach, the conventional texture extraction (i.e., extracting the texture of the whole garment) produces poor results. The proposed method calls for extraction of an undistorted one-repeat texture. We pro-pose a simple texture extraction method that can approximately produce visual impression of the original garment in the limited cases of regular patterns consisting of straight lines.

We eliminate the distortion first and then extract one-repeat texture from undistorted image. We extract the lines by applying the Sobel filter, then construct a 2D triangle mesh based on the extracted lines as shown in FIG. 7(b). We apply the deformation transfer technique [16] to straighten the above mesh.

T=\tilde{V}V⁻¹ (3)

To apply the deformation transfer method, we define the affine transformation T as

for each triangle, where V and V− represent undeformed and deformed triangle matrices, respectively. Using only the smoothness term E_{S} and the identity term E_{I},

$$\begin{matrix}{E}_{S} = {\sum }_{i = 1}^{\vert t \vert} {\sum }_{j ∈ adj ( i )} {‖ {T}_{i} - {T}_{j} ‖}_{F}^{2} & ( 4 ) \\ {E}_{I} = {\sum }_{i = 1}^{\vert t \vert} {‖ {T}_{i} - I ‖}_{F}^{2} & ( 5 )\end{matrix}$$

we formulate the optimization problem as

$$\begin{matrix}{min}_{{\tilde{V}}_{1} … {\tilde{V}}_{n}} E = {w}_{S} {E}_{S} + {w}_{I} {E}_{I} & ( 6 ) \\ subject to \\ {y}_{{\tilde{V}}_{i}} = {y}_{{\tilde{V}}_{j}} ( i , j ∈ {L}_{h} ) \\ {x}_{{\tilde{V}}_{i}} = {x}_{{\tilde{V}}_{j}} ( i , j ∈ {L}_{v} ) & \end{matrix}$$

where w_{S} and w_{I} are the user controlled weights, Lₕ and Lᵥ are horizontal and vertical lines, respectively, and y_{V-i} is y coordinate of vertex i. We use weights w_{S}=1.0 and w_{I}=0.001 as in [16]. The optimization produces straightened results as shown in FIGS. 7(c) and 7(d). Now, one-repeat texture (FIG. 7(e)) can be extracted by selecting the four corner points of the texture along the parallel straight lines.

### 4.6 Generating the Draft and Panels

After we get the garment type and the PBSs, we create the panels by supplying them to the parameterized drafting module. We map the one-repeat texture on the panels. Each garment type has the information on how to position and create seams between the panels. Each panel has the 3D coordinate for positioning. We has the index of the line pairs for stitching. After positioning and seaming panels, we perform the physically based clothing simulation [17, 18, 19].

### 5. RESULTS

We implemented the proposed garment capture method on a 3.2 GHz Intel Core™ i7-960 processor with 8 GB memory and a Nvidia GeForce GTX 560Ti video card. We ran the method to the left images of FIG. 8. The right side images of FIG. 8 show the results produced with GarmCap. For the physically-based static simulation, we set the mass density, stretching stiffness, bending stiffness, friction coefficient to 0.01 g/cm₂, 100 kg/s₂, 0.05 kgcm₂/s₂, 0.3, respectively, for the experiments shown in this paper. Running the proposed method took about three seconds per garment excluding the static simulation.

Our experiments included three dresses (FIG. 8(a)-(c)), two sweaters (FIG. 8(d)-(e)), one shirt (FIG. 8(f)), one H-line skirt (FIG. 8(g)), one A-line skirt (FIG. 8(h)), and two pairs of pants (FIG. 8(i)-(j)).

There can exist some discrepancies between captured and real garments. We measured the discrepancies in the corresponding PBSs (of the captured and real garments). For the garments experimented in this paper, the discrepancy was bounded by 3 cm.

The proposed method reproduces the shoulder strap (FIG. 8(b)) and the necklines (FIG. 8(a)-(f)) quite well. The method captures loose-fit garments (FIG. 8(a)-(h)) as well as normal-fit garments (FIG. 8(b)) very successfully. In capturing tight-fit garments, however, GarmCap may not accurately represent the tightness of the garment because the silhouette analysis cannot tell how much the garment is stretched. Due to above problem, for example, some wrinkles are produced in the captured result of FIG. 8(g).

Intrinsically, the proposed method can not capture the input garment accurately when its draft does not exist in the database. In FIG. 8(h), whereas the skirt has pleats at the bottom end, our method produces an A-line skirt since the pleated skirt is not in the database. In spite of the missing pleats, we note that the results are visually quite similar.

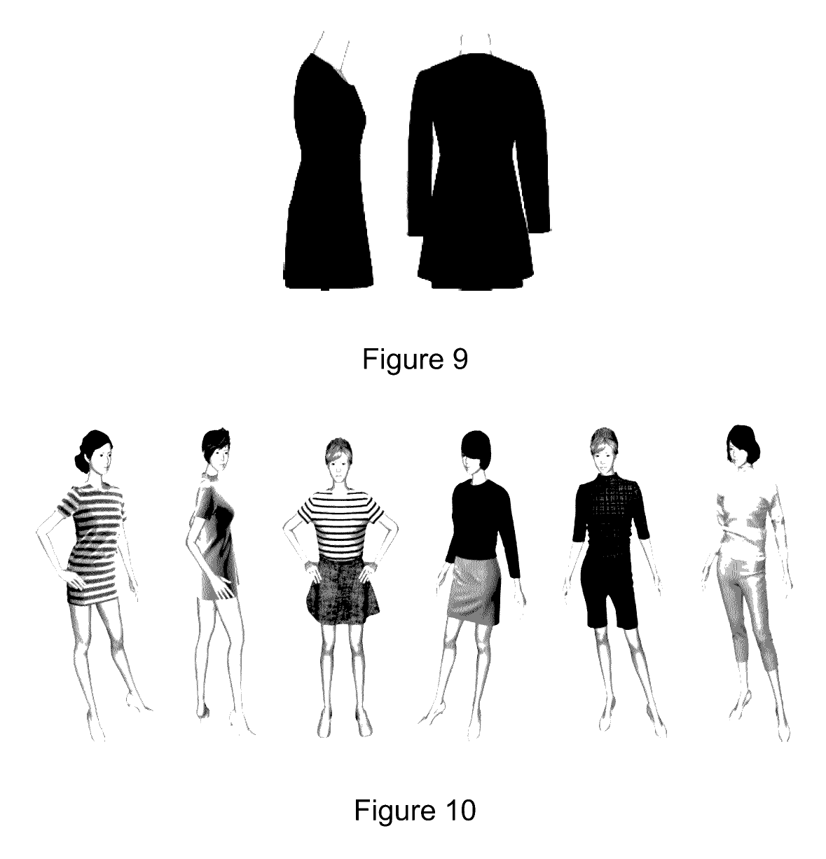

FIG. 9 shows the side and rear views of the virtual garment shown in FIG. 8(a). Although the method referenced only the frontal image, we note that the result is quite plausible from other views. We attribute the success to the fact that GarmCap is based the pattern drafting theory.

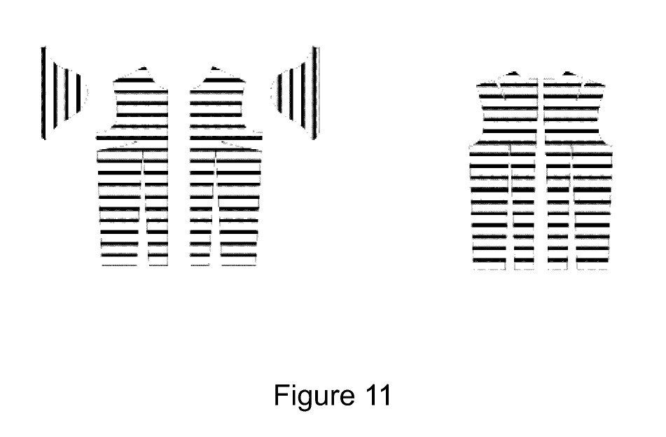

FIG. 11 shows the panels which have been automatically created for the captured garment in FIG. 1. FIG. 10 shows a few results which are put on to the avatar.

### 6. CONCLUSION

In this work, we proposed a novel method GarmCap that generates the virtual garment from a single photograph of a real garment. The method got the insight from the drafting of the garments in the pattern-making study. GarmCap abstracted the drafting process into a computer module, which takes the garment type and PBSs to produce the draft as the output. For identifying the garment type, GarmCap matched the photographed garment silhouette with the selections in the database. The method extracted the PBSs based on the distances between the garment silhouette landmark points. GarmCap also extracted the one-repeat texture in some limited cases based on the deformation transfer technique.

The virtual garment captured from the input photograph looks quite similar to the real garment. The method did not require any panel-flattening procedure, which contributed to obtaining realistic results. Although we created the virtual garment based on the front image, the result is plausible even when it is viewed from an arbitrary view.

The proposed method is based on the silhouette of the garment. Therefore, the method is difficult to represent the non-silhouette details of the garment such as wrinkles, collars, stitches, pleats and pockets. Therefore it would be challenging for the method to represent complex dresses (including traditional costumes). In the future, we plan to investigate the methods for more comprehensive garment capture techniques that can represent the above features.

While the invention has been shown and described with reference to different embodiments thereof, it will be appreciated by those skilled in the art that variations in form, detail, compositions and operation may be made without departing from the spirit and scope of the invention as defined by the accompanying claims.

### REFERENCES

[1] Helen Joseph Armstrong, Mia Carpenter, Michael Sweigart, Steve Randock, and James Venecia. Patternmaking for fashion design. Pearson Prentice Hall Upper Saddle River, N.J., 2006.
[2] Emmanuel Turquin, Marie-Paule Cani, and John F. Hughes. Sketching garments for virtual characters. In Proceedings of the First Eurographics Conference on Sketch-Based Interfaces and Modeling, SBM'04, pages 175-182, Aire-la-Ville, Switzerland, Switzerland, 2004. Eurographics Association.
[3] Philippe Decaudin, Dan Julius, Jamie Wither, Laurence Boissieux, Alla Sheffer, and Marie-Paule Cani. Virtual garments: A fully geometric approach for clothing design. Computer Graphics Forum (Eurographics'06 proc.), 25(3), sep 2006.
[4] Cody Robson, Ron Maharik, Alla Sheffer, and Nathan Carr. Smi 2011: Full paper: Context-aware garment modeling from sketches. Comput. Graph., 35(3):604-613, June 2011.
[5] Hiroaki Tanie, Katsu Yamane, and Yoshihiko Nakamura. High marker density motion capture by retroreflective mesh suit. In ICRA, pages 2884-2889. IEEE, 2005.
[6] Volker Scholz, Timo Stich, Michael Keckeisen, Markus Wacker, and Marcus Magnor. Garment motion capture using color-coded patterns. In Computer Graphics Forum (Proc. Eurographics EG05), pages 439-448, 2005.
[7] Ryan White, Keenan Crane, and D. A. Forsyth. Capturing and animating occluded cloth. ACM Trans. Graph., 26(3), July 2007.
[8] Derek Bradley, Tiberiu Popa, Alla Sheffer, Wolfgang Heidrich, and Tamy Boubekeur. Markerless garment capture. ACM Trans. Graph., 27(3):99:1-99:9, August 2008.
[9] Daniel Vlasic, Ilya Baran, Wojciech Matusik, and Jovan Popovic’. Articulated mesh animation from multi-view silhouettes. ACM Trans. Graph., 27(3):97:1-97:9, August 2008.
[10] Edilson de Aguiar, Carsten Stoll, Christian Theobalt, Naveed Ahmed, Hans-Peter Seidel, and Sebastian Thrun. Performance capture from sparse multi-view video. ACM Trans. Graph., 27(3):98:1-98:10, August 2008.
[11] Carsten Stoll, Juergen Gall, Edilson de Aguiar, Sebastian Thrun, and Christian Theobalt. Video-based reconstruction of animatable human characters. ACM Trans. Graph., 29(6):139:1-139:10, December 2010.
[12] Tiberiu Popa, Q. Zhou, D. Bradley, Vladislav Kraevoy, H. Fu, Alla Sheffer, and Wolfgang Heidrich. Wrinkling captured garments using space-time data-driven deformation. Comput. Graph. Forum, 28(2):427-435, 2009.
[13] Bin Zhou, Xiaowu Chen, Qiang Fu, Kan Guo, and Ping Tan. Garment modeling from a single image. Comput. Graph. Forum, pages 85-91, 2013.
[14] Moon-Hwan Jeong and Hyeong-Seok Ko. Draft-space warping: grading of clothes based on parametrized draft. Journal of Visualization and Computer Animation, 24(3-4):377-386, 2013.
[15] Carsten Rother, Vladimi Kolmogorov, and Andrew Blake. “grabcut”: Interactive foreground extraction using iterated graph cuts. ACM Trans. Graph., 23(3):309-314, August 2004.
[16] Robert W. Sumner and Jovan Popovic’. Deformation transfer for triangle meshes. ACM Trans. Graph., 23(3):399-405, August 2004.
[17] David Baraff and Andrew Witkin. Large steps in cloth simulation. In Proceedings of the 25th Annual Conference on Computer Graphics and Interactive Techniques, SIGGRAPH '98, pages 43-54, New York, N.Y., USA, 1998. ACM.
[18] David Baraff, Andrew Witkin, and Michael Kass. Untangling cloth. ACM Trans. Graph., 22(3):862-870, July 2003.
[19] Pascal Volino and Nadia Magnenat-Thalmann. Resolving surface collisions through intersection contour minimization. ACM Trans. Graph., 25(3):1154-1159, July 2006.

What is claimed is:

1. A method for garment capturing from a photograph of a garment, the method comprising steps for:
inputting a photograph of the garment;
extracting a silhouette of the garment from the photograph;
identifying a garment type and a plurality of primary body sizes (PBSs) and creating a plurality of sized drafts;
generating a plurality of panels using the garment type and the plurality of PBSs; and
draping the plurality of panels on a mannequin.

2. The method of claim 1, prior to the step for inputting, further comprising steps for:
providing a camera and the mannequin, wherein the positions of the camera and the mannequin are fixed, so that photographs taken with and without the garment have pixel-to-pixel correspondence; and
pre-processing the mannequin to obtain and store three-dimensional geometry of the mannequin and primary body sizes (PBSs).

3. The method of claim 2, wherein the step for pre-processing the mannequin comprises steps for:
scanning the mannequin;
modeling the scanned data graphically; and
storing the graphically modeled data in a computer file,
wherein relationship between real world distance and pixel distance of a plurality points of the mannequin and an environment in which the camera and the mannequin are disposed is established a computer using the graphically modeled data.

4. The method of claim 2, wherein the step for extracting a silhouette comprises a step for providing a base mask by subtracting an exposed mask from a mannequin mask, wherein the mannequin mask is obtained from the input photograph of the mannequin and the exposed mask comprises a non-garment region of the input photograph.

5. The method of claim 2, wherein the step for identifying a garment type comprises a step for searching a closest match from choices in a garment type database using
$$arg {min}_{{S}_{D}} ‖ {TS}_{I} - {S}_{D} ‖ , \qquad ( 1 )$$
where S_{I} is an input garment silhouette image, S_{D} the silhouette in the garment type database, and T a transformation comprising an arbitrary combination of rotation, translation, and scaling.

6. The method of claim 5, wherein the garment type database comprises a plurality of classes and subclasses.

7. The method of claim 2, wherein the step for identifying a plurality of primary body sizes (PBSs) comprises a step for identifying, labeling, and pre-registering of mannequin-silhouette landmark points (MSLPs) and garment-silhouette landmark points (GSLPs).

8. The method of claim 7, wherein the plurality of primary body sizes (PBSs) are identified by searching candidate points of the garment-silhouette according to
$$arg {min}_{{M}_{L}} ‖ {M}_{F} - {M}_{L} ‖ , \qquad ( 2 )$$
where M_{F} is one of the filters shown in FIG. 6, M_{L} is the square fraction of the silhouette image.

9. The method of claim 2, further comprising a step for extracting one-repeat texture from the input photograph.

10. The method of claim 9, wherein the step for extracting one-repeat texture comprises steps for eliminating distortion first and then extracting the one-repeat texture from an undistorted image.

11. The method of claim 10, wherein the step for extracting one-repeat texture comprises a step for extracting lines by applying the Sobel filter, then constructing a 2D triangle mesh based on the extracted lines.

12. The method of claim 11, wherein a deformation transfer technique is applied to straighten the 2D triangle mesh, using an affine transformation T as
T=\tilde{V}V⁻¹ (3)
for each triangle, where V and V− represent undeformed and deformed triangle matrices, respectively, and using only a smoothness term E_{S} and an identity term E_{I},
$$\begin{matrix}{E}_{S} = {\sum }_{i = 1}^{\vert t \vert} {\sum }_{j ∈ adj ( i )} {‖ {T}_{i} - {T}_{j} ‖}_{F}^{2} & ( 4 ) \\ {E}_{I} = {\sum }_{i = 1}^{\vert t \vert} {‖ {T}_{i} - I ‖}_{F}^{2} & ( 5 )\end{matrix}$$
and formulating the optimization problem as
$$\begin{matrix}{min}_{{\tilde{V}}_{1} … {\tilde{V}}_{n}} E = {w}_{S} {E}_{S} + {w}_{I} {E}_{I} & ( 6 ) \\ subject to \\ {y}_{{\tilde{V}}_{i}} = {y}_{{\tilde{V}}_{j}} ( i , j ∈ {L}_{h} ) \\ {x}_{{\tilde{V}}_{i}} = {x}_{{\tilde{V}}_{j}} ( i , j ∈ {L}_{v} ) & \end{matrix}$$
where w_{S} and w_{I} are the user controlled weights, Lₕ and Lᵥ are horizontal and vertical lines, respectively, and y_{V-i} is y coordinate of vertex i.
